(19) United States
(12) Patent Application Publication
(10) Pub. No.: US 2021/0402719 A1
(43) Pub. Date: Dec. 30, 2021

(54) VEHICLE COMPONENT BASED ON SELECTIVE COMMINGLED FIBER BUNDLE HAVING INTEGRAL ELECTRICAL HARNESS AND EMBEDDED ELECTRONICS

(71) Applicant: COATS & CLARK, INV., Charlotte, NC (US)

(72) Inventors: Probir Kumar Guha, Uxbridge (GB); George Han, Uxbridge (GB); Todd Pool, Uxbridge (GB)

(73) Assignee: J&P COATS LIMITED, Glasgow (GB)

(21) Appl. No.: 17/292,077

(22) PCT Filed: Nov. 13, 2019
(86) PCT No.: PCT/US2019/061194

§ 371 Date: May 7, 2021

Related U.S. Application Data
(60) Provisional application No. 62/889,238, filed on Aug. 20, 2019.
(60) Provisional application No. 62/760,216, filed on Nov. 13, 2018.

(51) Int. Cl. B29C 70/88; B29C 70/34; B60R 16/02

(52) U.S. Cl. CPC B29C 70/885; B29K 2101/12; B60R 16/0207; B29C 70/345

(57) ABSTRACT

A form for a vehicle component including a commingled fiber bundle laid out in a two-dimensional base layer that defines a shape of the form, a successive layer formed with the commingled fiber bundle in contact with the two-dimensional layer, and at least one of electrical conductive wiring, sensor, light emitting diode (LED), antenna, radio frequency identification chip, or a printed circuit board stitched to the successive layer. The comingled fiber bundle is composed of a reinforcement fiber being glass fibers, aramid fibers, carbon fibers, or a combination thereof.

### RELATED APPLICATIONS

This application claims priority benefit of U.S. Provisional Application Ser. No. 62/760,216 filed 13 Nov. 2018, and U.S. Provisional Application Ser. No. 62/889,238 filed on 20 Aug. 2019, the contents of which are hereby incorporated by reference.

### FIELD OF THE INVENTION

The present invention in general relates to composite vehicle components and in particular, to unitary reinforced composite based vehicle components with an integral electrical harness with embedded electronics and associated terminations.

### BACKGROUND OF THE INVENTION

Weight savings in the automotive, transportation, and logistics based industries has been a major focus in order to make more fuel-efficient vehicles both for ground and air transport. In order to achieve these weight savings, light weight composite materials have been introduced to take the place of metal structural and surface body components and panels. Composite materials are materials made from two or more constituent materials with significantly different physical or chemical properties, that when combined, produce a material with characteristics different from the individual components. The individual components remain separate and distinct within the finished structure. A composite material may be preferred for many reasons: common examples include materials which are stronger, lighter, or less expensive when compared to traditional materials.

As vehicles are increasingly platforms for ever more complex sensors and computerized systems, the complexity of a vehicle electrical harness and the time needed for installation have also increased. Traditionally, sets of wires are cut to predetermined lengths and tied into bundles with connectors that must then be joined to structural components during vehicle assembly. Such harnesses have become increasingly impractical and time consuming to couple to not only vehicle electrical components, but also sensors and central processing units (CPUs). Traditional electrical harnesses also suffer from vibrationally induced wear caused by vehicle operation. The shorting of a wire within an electrical harness is difficult to repair.

As part of an effort to reduce vehicle weight and ease of manufacture has moved towards composite materials. These composite materials include a matrix material that surrounds and supports the reinforcement materials by maintaining their relative positions. The reinforcements impart their special mechanical and physical properties to enhance the matrix properties. A synergism produces material properties unavailable from the individual constituent materials, while the wide variety of matrix and strengthening materials allows the designer of the product or structure to choose an optimum combination.

Commercially produced composites often use a polymer matrix material that is either a thermoplastic or thermoset resin. There are many different polymers available depending upon the starting raw ingredients which may be placed into several broad categories, each with numerous variations. Examples of the most common categories for categorizing polymers include polyester, vinyl ester, epoxy, phenolic, polyimide, polyamide, polypropylene, PEEK, and others.

The use of fiber and particulate inclusions to strengthen a matrix is well known to the art. Well established mechanisms for the strengthening include slowing and elongating the path of crack propagation through the matrix, as well as energy distribution associated with pulling a fiber free from the surrounding matrix material. In the context of sheet molding composition (SMC) formulations, bulk molding composition (BMC) formulations, and resin transfer molding (RTM); hereafter referred to collectively as “molding compositions”, fiber strengthening has traditionally involved usage of chopped glass fibers. There is a growing appreciation in the field of molding compositions that replacing in part, or all of the glass fiber in molding compositions with carbon fiber can provide improved component properties.

Fiber-reinforced composite materials can be divided into two main categories normally referred to as short fiber-reinforced materials and continuous fiber-reinforced materials. Continuous reinforced materials often constitute a layered or laminated structure. The woven and continuous fiber styles are typically available in a variety of forms, being pre-impregnated with the given matrix (resin), dry, uni-directional tapes of various widths, plain weave, harness satins, braided, and stitched. Various methods have been developed to reduce the resin content of the composite material, by increasing the fiber content. Typically, composite materials may have a ratio that ranges from 60% resin and 40% fiber to a composite with 40% resin and 60% fiber content. The strength of a product formed with composites is greatly dependent on the ratio of resin to reinforcement material. The construction method of selective placement of commingled fiber bundles being stitched in place offers new opportunities to integral electrical wiring within a vehicle component.

Thus, there exists a need to form a vehicle component having an electrical harness with embedded electronics integral therein.

### SUMMARY OF THE INVENTION

The present invention provides a form for a vehicle component including a commingled fiber bundle laid out in a two-dimensional base layer that defines a shape of the form, a successive layer formed with the commingled fiber bundle in contact with the two-dimensional layer, and at least one of electrical conductive wiring, sensor, light emitting diode (LED), antenna, radio frequency identification chip, or a printed circuit board stitched to the successive layer. The comingled fiber bundle is composed of a reinforcement fiber being glass fibers, aramid fibers, carbon fibers, or a combination thereof. The comingled fiber bundler is optional further composed of thermoplastic fibers that can be melted to form a matrix around the reinforcing fibers in the comingled fiber bundle. The form is suitable to use with any known composite component processing technique, such as RTM, LCM, thermoplastic overmolding, injection molding, and the like. The inventive forms are used for making finished vehicle components with integrated electrical components and/or wiring such a vehicle panel, a dashboard, body panel, door component, roof components, or decklids.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a schematic illustrating a selective commingled fiber bundle positioning (SCFBP) form created from a continuous fiber bundle inclusive of electrical wiring according to the present invention;

FIG. 2 is a cross section representation of a SCFBP form, where C stands for a carbon fiber rich commingled fiber bundle, G stands for glass fiber rich commingled fiber bundle, and W stands for an electrical distribution wire in accordance with embodiments of the invention;

FIG. 3 is a schematic illustrating a SCFBP form created according to the present invention inclusive of a printed circuit board (PCB);

FIG. 4 is a top view of a preform with a stitched conductor an embedded antenna with external electrical terminations for connection to a control board and touch sensor and a light emitting diode (LED) in accordance with embodiments of the invention;

FIG. 5A is a top view of a preform with stitched LED strips with a termination for a ribbon cable in accordance with embodiments of the invention;

FIG. 5B is a top schematic view of FIG. 5A in accordance with embodiments of the invention;

FIGS. 6A-6C are prior art block diagram examples of wireless power transfer networks including inductive, resonant inductive, and capacitive, respectively;

FIG. 7 is a top view of a preform with conductors joined to a wireless power transfer circuit and to external terminations in accordance with embodiments of the invention;

FIG. 8 is a perspective view of a power source connected via external terminations to over lapping or coupled panels formed with preforms having wireless power transfer circuits for powering embedded electronics in accordance with embodiments of the invention; and

FIGS. 9A-9C are a sequence of schematic steps of processing an inventive SCFBP form into a vehicle component by melting thermoplastic content of the SCFBP form.

### DESCRIPTION OF THE INVENTION

The present invention has utility as a unitary reinforced composite based panel component, and methods of construction thereof inclusive of electrical wiring and associated embedded electrical components. A vehicle component is prepared with resort to selective commingled fiber bundle positioning (SCFBP) to selectively place co-mingled fibers that are in some inventive embodiments enriched in carbon fiber as a reinforcement relative to other region that rely on a relatively higher percentage of glass fiber reinforcement while internalizing electrical wiring and associated electrical components within the vehicle part. By internalizing an electrical harness function within a vehicle part, vehicle assembly is simplified and vibrationally induced wear observed in a traditional electrical harness is eliminated.

In specific inventive embodiments, commingled reinforcing fibers of glass, carbon, polyaramid, or a combination thereof are used to form a yarn that has predictable strength, and where the ratio of different fiber types is varied to create different properties along a given length. According to embodiments, the commingled fiber based yarn optionally also includes a plurality of thermoplastic threads comingled with the reinforcing fibers in the yarn. The commingled fiber based yarn may be used in the formation of the SCFBP forms, and are able to be embroidered directly into complex shapes thereby eliminating trimming waste and inefficient usage of comparatively expensive carbon fiber. In specific inventive embodiments, SCFBP forms include from 3 to 20 layers that vary in fiber types in three dimensions (3D). Electrically conductive insulated wire is also stitched by the SCFBP process into the form to create pre-selected electrical pathways. The final panel is them formed by melting any thermoplastic fibers within the SCFBP form in contact with at least one mold platen complementary to the finished vehicle component to form a vehicle panel such as a dashboard, body panel, door component, roof components, or decklids.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

SCFBP-technology offers several advantages including:
varying the angle of fiber positioning during the lay-up process freely between 0 and 360°;
repeated fiber positioning on the same area allows for local thickness variations in the fiber form suited for a fiber composite component,
the conversion of the desired fiber orientation in a fiber positioning pattern for an embroidery machine requires minor development times and costs,
the process allows a near-net-shape production, which results in low waste and optimal fiber exploitation,
the ability to process a variety of fibers such as natural, glass, aramid, carbon (high strength and high modulus) and ceramic fibers.

As used herein, a veil includes woven sheets, non-woven sheets, and films of thermoplastics, glass, or aramids; or woven sheets, non-woven sheets of carbon fibers.

As used herein, any reference to weight percent or by extension molecular weight of a polymer is based on weight average molecular weight.

As used herein, the term melting as used with respect to thermoplastic fibers or thread is intended to encompass both thermofusion of fibers such that a vestigial core structure of separate fibers is retained, as well as a complete melting of the fibers to obtain a homogenous thermoplastic matrix.

Commingled fibers as a roving are made up of commingled reinforcing fibers, illustratively including those made of carbon, glass, or aramid fibers, and optionally thermofusible fibers which serve to provide a matrix in a composite material made of both reinforcing and matrix fibers. The optional matrix fibers, being of a thermofusible nature may be formed from material such as, for example, polyamide, polypropylene, polyester, polyether ether ketone, polybenzobisoxazole, or liquid crystal polymer. The reinforcing fibers may also be of a material that is meltable with the proviso that melting occurs at a temperature which is higher than the any matrix fibers so that, when both fibers are used to create a composite, at the temperature point at which melting of the matrix fibers occurs, the state of the reinforcing fibers is unaffected.

According to embodiments the commingled fibers are made up of only reinforcing fibers and not thermoplastic fiber. The reinforcement fibers in a commingled fiber bundle being glass fibers, polyaramid, carbon fibers, or a combination of any of the aforementioned. It is appreciated that the commingled fibers are either parallel to define a roving or include at some fibers that are helically twisted to define a yarn. It is appreciated that the physical properties of reinforcing fibers retained in a helical configuration within a fixed matrix of a completed vehicle component are different than those of a linear configuration, especially along the reinforcing fiber axis.

According to further embodiments, the commingled fibers used in the present invention are composed of both thermoplastic fibers and a reinforcement fiber. Thermoplastic fibers operative herein illustratively include, polypropylenes, polyamides, polyesters, polyether ether ketones, polybenzobisoxazoles, polyphenylene sulfide; block copolymers containing at least of one of the aforementioned constituting at least 40 percent by weight of the copolymer; and blends thereof. The optional thermoplastic fibers are appreciated to be recycled, virgin, or a blend thereof. The thermoplastic fibers in a commingled fiber bundle constitute from 20 to 80 weight percent of the commingled fibers in the present invention. The relative number of reinforcing fibers relative to any thermoplastic fibers present is highly variable in the present invention in view of the disparate diameters of glass fibers, polyaramid fibers, and carbon fibers.

An inventive form is created by laying out one or more commingled fiber bundles on a substrate as a two-dimensional base layer that defines a shape of the form with stitching applied to retain the commingled fibers in a desired placement on the substrate. As is conventional to SCFBP, the substrate can be removed after production of the form, else it is retained and thereby incorporated into the resulting vehicle component. According to embodiments of the present invention, the stitching thread is a thermoplastic thread, glass fiber thread, carbon fiber thread, aramid fiber thread, a metal wire, or a combination thereof. The thread diameter and thread material used for stitching are variables that are readily selected relative to the properties of comingled fiber bundle and the desired properties of the resulting preform and vehicle component. In certain inventive embodiments, the stitching is a thermoplastic thread. The thermoplastic thread in some inventive embodiments is formed of the same thermoplastic present in the commingled fiber bundle. It is appreciated that the thread diameter and melting temperature of the thread used for stitching are variables that are readily selected relative to the properties of commingled fiber bundle.

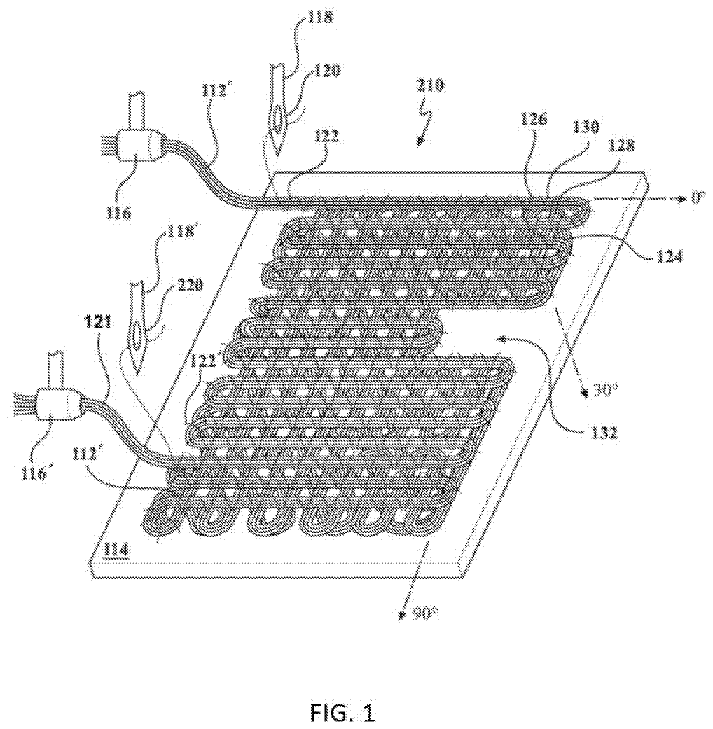

As shown in FIG. 1, an inventive form is shown generally at 210 is in the process of being created. The commingled fiber bundle 112 is conveyed to a substrate 114 by a guide pipe 116 to lay out the commingled fiber bundle 112 in predetermined pattern on the substrate 114. A conventional sewing machine head operating a needle 118 with a top thread 120 tacks the commingled fiber bundle 112 with stitches 122. A bobbin below the substrate 114, includes a bobbin with a lower thread are not shown, and are conventional to sewing machines. The top thread 120 and the bottom thread are thermoplastic thread, glass fiber thread, carbon fiber thread, aramid fiber thread, a metal wire, or a combination thereof. In certain inventive embodiments, the commingled fiber bundle 112 is laid out in a base layer 124 in generally parallels lines with a given orientation. Switchback turn regions 126 are commonly used to lay out parallel lines of commingled fiber bundle 112. A base layer 124 has an orientation of 30 degrees, while a first successive layer 128, and a second successive layer 130 have orientations of 90 degrees and 0 degrees, respectively. This is best seen in the notch region 132 in the form 210. A second conventional sewing machine head' operating a needle 118′ with a top thread 220 tacks an electrical wiring 121 with stitches 122′. The electrical wiring 121 is bare electrically conductive wiring, insulated electrical wiring, and a coil of either of the aforementioned around a carrier fiber or bundle of carrier fibers. The electrical wiring 121 is readily formed from conventional materials such as copper, copper alloys, stainless steel, galvanized steel, aluminum, aluminum alloys, and gold. A second bobbin below the substrate 114, includes a bobbin with a lower thread are not shown, and are conventional to sewing machines. The top threads 120 and 220, can be the same or different and likewise the bottom threads. The needle 118 in FIG. 1 is devoted to only applying a uniform commingled fiber bundle 112. While only two separate sewing heads are shown in FIG. 1, it should be appreciated that additional sewing heads are readily used to simultaneous stitch commingled fiber bundles to create a form or to vary the amount or type of reinforcing fiber relative to the bundle 112. This being especially the case when the form is for a large area form as might be employed in a vehicle component such as a floor.

As a result of the present invention, the form 210 includes specific features such as the notch region 132 that conventionally would be cut from a base piece. In this way, the present invention eliminates the cutting step, as well as the associated waste generation while including electrical wiring within the form. In addition to the substantially linear pattern of commingled fiber bundle positioning depicted in FIG. 1 with interspersed switchbacks, it is appreciated that other patterns operative herein illustratively include spirals, and any space filling curve such as a Peano curve, dragon curve, or Sierpinksi curve.

If zero degrees is defined as the long axis of the base layer 124, the subsequent layers are overlaid at angles of 0-90°. For example, an angular displacement between adjacent layers is 45° resulting in a 0-45-90-45-0 pattern of layers. Further specific patterns illustratively include 0-45-90-45-0, 0-45-60-60-45-0, 0-0-45-60-45-0-0, 0-15-30-45-60-45-30-15-0, and 0-90-45-45-60-60-45-45-90-0. While these exemplary patterns are for from 5 to 10 layers of directional SCFBP, it is appreciated that the form 210 may include from 3 to 20 layers. It is appreciated that the form layers may be symmetrical about a central layer, in the case of an odd number of layers, or about a central latitudinal plane parallel to the players.

The stitching 122 or 122′ is applied with a preselected tension, stitching diameter, stitch spacing. The stitching 122 or 122′ is typically present in an amount of from 0.1 to 7 weight percent of the commingled fiber bundle 112′ or wiring 121, respectively.

While FIG. 1 only shows three layers, it is appreciated that a form 210 is readily formed with up to 20 layers with the only technical limit being the length of the travel of the needle 118.

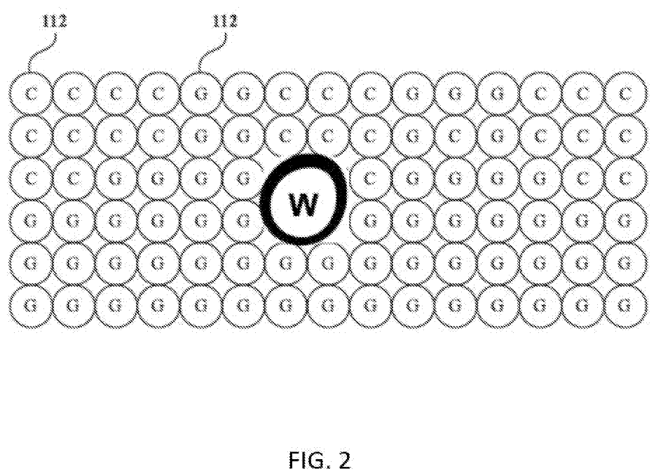

A cross-sectional view of an exemplary form similar to form 210 is shown in FIG. 2 with six layers, where C denotes a carbon fiber enriched commingled fiber bundle 112, G denotes a carbon fiber depleted commingled fiber bundle 112 to illustrate regions of selective toughening to enforce the edges and center of the form, and W denotes wiring 121. In this way carbon fiber is used efficiently to toughen while the part includes electrical wiring. In contrast to the form 210, with adjacent layers varying in angle, FIG. 2 shows the adjacent layers parallel for visual clarity. No stitches are shown for visual clarity.

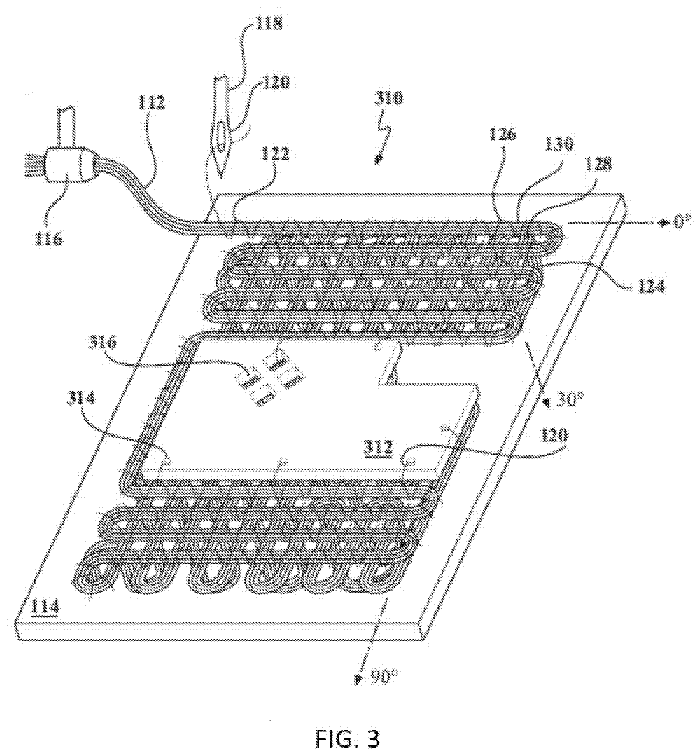

As shown in FIG. 3, in which like reference numerals have the meaning previously ascribed thereto, an inventive form 310 is in the process of being created. This embodiment varies from that detailed with respect to FIG. 1 in that a printed circuit board (PCB) 312 is stitched into the form 310. Preformed holes 314 in the PCB 312 are present in certain inventive embodiments that are sized and spaced to receive thread 120. In still other inventive embodiments, a veil is overlaid on the top surface of form 310 to encompass a top layer strut in thermoplastic material.

While the inclusion of a PCB 312 in a form is illustrated in FIG. 3 relative to FIG. 1, it is appreciated that a PCB 312 is also readily employed with devoted sewing head. It is further appreciated that the PCB 312 is prepopulated with electrical components that are soldered to the PCB 312 with a solder having a melting point above the temperature at which over-molding of the form 310 occurs.

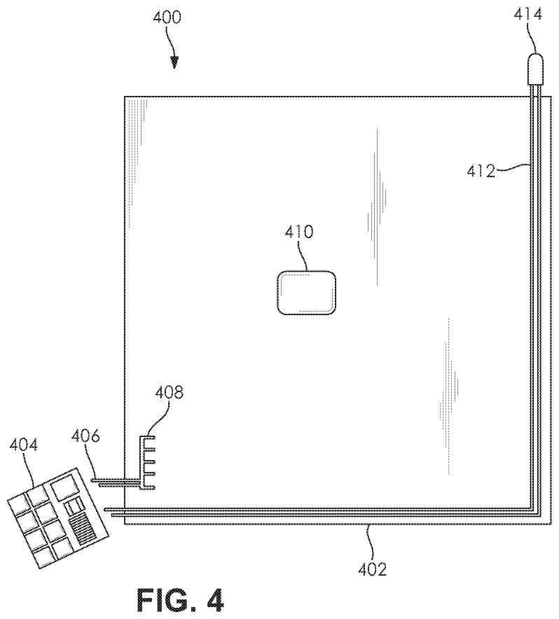

FIG. 4 is a top view of an inventive preform 400 with a stitched conductor 402 formed of the electrical wiring as detailed above that also forms an embedded antenna 412. A light emitting diode (LED 414) is in electrical communication with the conductor 402 and can be activated based on antenna activation associated with receipt of a wireless signal that for example, is associated with the proximity of a key fob for a vehicle. External electrical terminations 406 serve as a connection to a control board and/or touch sensor 404 that controls the LED 414. In a specific embodiment the control board may be on a flexible circuit board. Also shown in FIG. 4, a radio frequency identification (RFID) chip is stitched to the preform 400. It is also appreciated that sensors illustratively including capacitive touch sensors, temperature sensors may be integrated into embodiments of the preform 400. Once the wires and electrical components are sewn into place, the resulting preform is subjected to conventional molding techniques such as thermoplastic compression overmolding, thermoset compression overmolding, or resin transfer molding (RTM). Non-limiting examples of where inventive composite assemblies may be used in a vehicle illustratively include the dashboard, roof, and doors, a dashboard, or a central console. The inclusion of wireless antennae and independent powers sources (battery, solar cell, wind driven dynamo power) allow for independent function from the electrical system of the vehicle chassis for assemblies illustratively including a lift gate, detachable roof, door, etc., without running physical wires, which are prone to wear and failure at connection points. In addition to improved long-term reliability, the manufacturing and assembly of the vehicle is simplified.

According to embodiments of the present invention, an inventive preform is suitable to use with any known composite component processing technique, such as RTM, LCM, thermoplastic overmolding, injection molding, and the like.

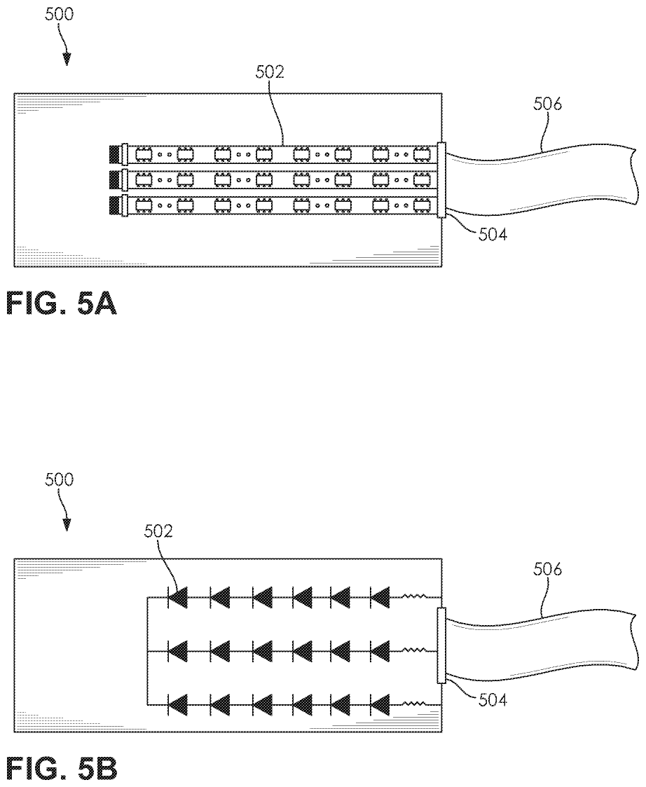

FIG. 5A is a top view of an embodiment of an inventive preform 500 with stitched LED strips 502 with an electrical termination 504 for joining a ribbon cable 504. The preform 500 may be ovemolded with a clear or transparent thermoplastic for use as a turn signal or rear vehicle brake light. Alternatively, only the backside of the preform may be melted into thermoplastic for joining to a lens cover. In a further inventive embodiment, a surface cloth with cutouts may be used for the LED strips 502 that provides a quick route to a vehicle roof interior. FIG. 5B is a top schematic view of FIG. 5A showing the electrical connections in the LED strips 502 and the electrical termination 504.

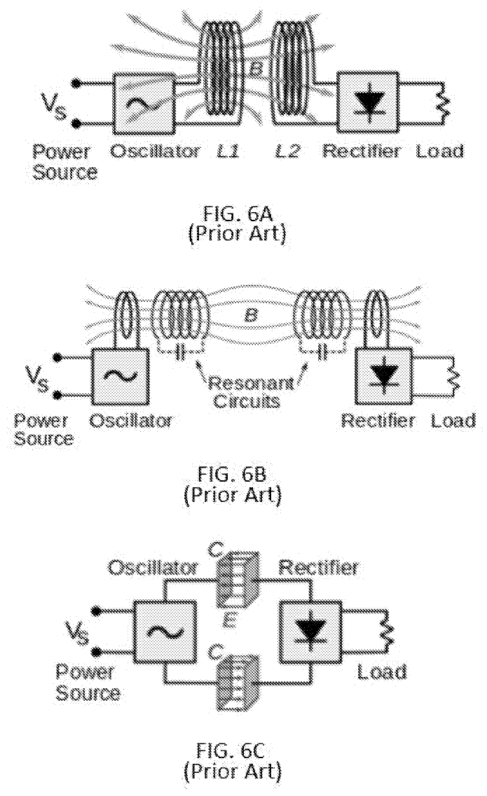

FIGS. 6A-6C are prior art block diagram examples of wireless power transfer networks including inductive, resonant inductive, and capacitive, respectively. FIG. 6A illustrates inductive coupling (electromagnetic induction or inductive power transfer, IPT) In FIG. 6A power is transferred between coils of wire by a magnetic field. The transmitter and receiver coils (L1, L2) together form a transformer, where an alternating current (AC) through the transmitter coil L1 creates an oscillating magnetic field B by Ampere's law. The magnetic field B passes through the receiving coil L2, where the magnetic field B induces an alternating EMF (voltage) by Faraday's law of induction, which creates an alternating current in the receiver coil L2. The induced alternating current may either drive the load directly, or be rectified to direct current (DC) by a rectifier in the receiver, which drives the load. Non-limiting examples of a load may be a sensor or an array of LEDs. FIG. 6B is a block diagram showing resonant inductive coupling. The resonance between the coils can greatly increase coupling and power transfer. FIG. 6C is a block diagram showing capacitive coupling (electrostatic induction). Capacitive coupling is the conjugate of inductive coupling, where energy is transmitted by electric fields between electrodes such as metal plates. The transmitter and receiver electrodes form a capacitor, with the intervening space as the dielectric. An alternating voltage generated by the transmitter is applied to the transmitting plate, and the oscillating electric field induces an alternating potential on the receiver plate by electrostatic induction, which causes an alternating current to flow in the load circuit.

The use of wireless power transfer networks allows for electrical functions in assemblies illustratively including for example, a lift gate, detachable roof, door, a dashboard, or a central console, all without running physical wires, which are prone to wear and failure at connection points. In addition to improved long-term reliability, the manufacturing and assembly of the vehicle is simplified.

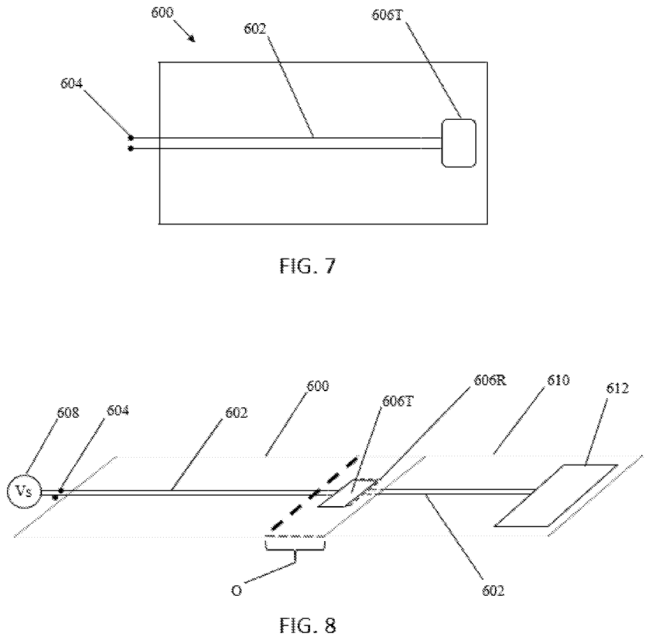

FIG. 7 is a top view of an inventive preform 600 with conductors 602 joined to a transmitting portion of a wireless power transfer circuit 606T and to external terminations 604. The wireless power transfer circuit 606T may be one of the networks shown in FIGS. 6A-6C.

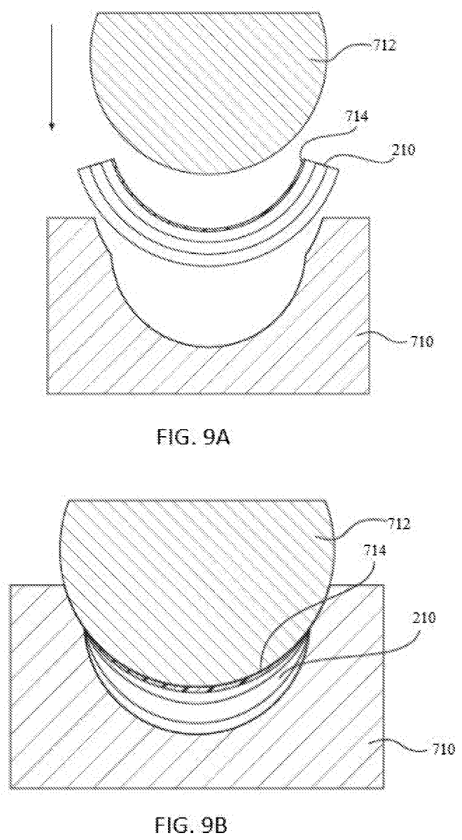

FIG. 8 is a perspective view of a power source 608 connected via external terminations 608 to over lapping or coupled panels (600, 610) formed with overmolded preforms having wireless power transfer circuits (606T, 606R) for powering embedded electronics shown as load 612. As shown in the overlap region O the panels (600, 610) are secured together such that the transmitting power transfer circuit 606T is positioned or aligned above the receiving power transfer circuit 606R so as to facilitate the conduction of current to the load 612.

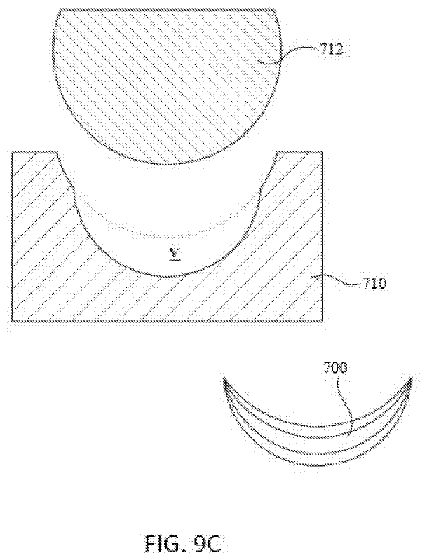

FIGS. 9A-9C are a series of schematics showing melt formation of a vehicle component 700. In FIG. 9A, form 210 is intended to be brought into simultaneous contact with opposing mold platens 710 and 712 that define a cavity volume, V. The volume V corresponding in shape to the desired vehicle component. By selectively heating one or both of the platens 710 or 712 to a temperature sufficient to melt any thermoplastic content of the form 210, but not the insulation surrounding the wiring 121, a vehicle component is formed upon cooling the mass compressed within the platens 710 and 712 by temperature and pressure, as shown in FIG. 9B. In a specific inventive embodiment, a thermoplastic veil 714 is in contact one or both platens 710 and 712 to create a skin on the resulting vehicle component. Upon opening the volume V, a completed vehicle component 700 is removed, as shown in FIG. 9C.

The foregoing description is illustrative of particular embodiments of the invention, but is not meant to be a limitation upon the practice thereof. The following claims, including all equivalents thereof, are intended to define the scope of the invention.

1. A form for a vehicle component comprising:
a commingled fiber bundle composed of a reinforcement fiber, said reinforcement fiber being glass fibers, aramid fibers, carbon fibers, or a combination thereof, said commingled fiber bundle laid out in a two-dimensional base layer that defines a shape of the form;
a successive layer formed with said commingled fiber bundle in contact with said two-dimensional layer; and
at least one of electrical conductive wiring, sensor, light emitting diode (LED), antenna, radio frequency identification chip, or a printed circuit board stitched to said successive layer.

2. The form of claim 1 wherein the comingled fiber bundle is further composed of thermoplastic fibers.

3. The form of claim 1 wherein said electrical conductive wiring is present and is insulated.

4. The form of claim 1 wherein said printed circuit board is present.

5. The form of claim 1 wherein both said electrically conductive wiring and said printed circuit board are present.

6. The form of claim 1 wherein said electrical conductive wiring extends outward from said form as an electrical termination.

7. The form of claim 1 wherein the reinforcement fiber is exclusively only the glass fibers.

8. The form of claim 1 wherein the reinforcement fiber is exclusively only the carbon fibers.

9. The form of claim 1 wherein the reinforcement fiber is enriched in carbon fiber in certain regions relative to glass fibers.

10. The form of claim 1 wherein said first successive layer is angularly displaced relative to said base layer.

11. The form of claim 1 further comprising one to seventeen additional successive layers placed on said first successive layer.

12. (canceled)

13. The form of claim 1 wherein the form is formed using selective commingled fiber bundle positioning (SCFBP), where the form is held together with stitching of a thread.

14. (canceled)

15. (canceled)

16. The form of claim 1 further comprising a receiving or transmitting wireless power transfer circuit.

17. The form of claim 16 wherein the receiving and the transmitting wireless power transfer circuit form one of an inductive, resonant inductive, and capacitive power transfer circuit.

18. (canceled)

19. A method of forming a unitary reinforced composite component comprising:
placing the form of claim 1 onto a mold platen having a shape,
heating the perform to shape the form to the shape of the mold platen therein;
cooling the perform until solidified; and
removing the shaped form from the mold platen.

20. The method of claim 19 further comprising applying a thermoplastic skin intermediate between the form and the mold platen.

21. The method of claim 19 further comprising applying a second opposing platen to apply pressure and sandwich the form.

22. The method of claim 19 wherein the unitary reinforced composite component is a vehicle component.

23. The method of claim 19 further comprising electrically connecting said electrically conductive wiring or said printed circuit board to an external electrical load.

24. The method of claim 22 wherein said vehicle component is a door, a lift gate, a dashboard, a central console, a dashboard, a body panel, a door component, a roof component, or a decklid.
